(19) United States
(12) Patent Application Publication
(10) Pub. No.: US 2012/0084758 A1
(43) Pub. Date: Apr. 5, 2012

(54) Collaborative Software Debugging In A Distributed System With Client-Specific Variable Evaluation

(75) Inventor: Cary L. Bates, Rochester, MN (US)

(73) Assignee: INTERNATIONAL BUSINESS MACHINES CORPORATION, Armonk, NY (US)

(21) Appl. No.: 12/897,921

(22) Filed: Oct. 5, 2010

(51) Int. Cl. G06F 11/36; G06F 3/048; G06F 15/16

(52) U.S. Cl. 717/125

(57) ABSTRACT

In a distributed system that includes a debug server and debug clients coupled for data communications through a data communications network, where the debug server includes a debug administrator, a message router, a back-end debugger, and a debuggee, collaborative software debugging includes receiving, by the debug server from the debug clients asynchronously during a debug session of the debuggee, a plurality of application-level messages; routing, by the message router in accordance with an application-level message passing protocol, the application-level messages among the debug clients, the debug administrator, and the back-end debugger, including providing distributed control of the back-end debugger to the debug clients with application-level messages routed to the back-end debugger; and returning, by the debug server to the debug clients in response to the application-level messages routed to the back-end debugger, client-specific debug results.

### BACKGROUND OF THE INVENTION

1. Field of the Invention

The field of the invention is data processing, or, more specifically, methods, apparatus, and products for collaborative software debugging in a distributed system.

2. Description of Related Art

Software source code is increasingly complex and is often developed by various developers, sometimes physically dispersed from one another. One part of software development, source code debugging, is especially complex in today's distributed software development environments. In debugging, it is often useful for two or more developers to work together in real-time to debug the source code. Further, during such debugging, developers may have differing interests in different portions of the source code. At present, there are no debug engines available that enable remotely distributed developers to debug the same source code collaboratively in real-time, while separately viewing different results of the same debugging.

### SUMMARY OF THE INVENTION

Methods, apparatus, and products for collaborative software debugging in a distributed system are disclosed. In embodiments of the present invention, the distributed system includes a debug server, a plurality of debug clients, and a data communications network. The debug server is coupled for data communications to the plurality of debug clients through the data communications network and the debug server includes a debug administrator, a message router, a back-end debugger, and a debuggee. From the perspective of the debug server, collaborative software debugging in the distributed system includes: receiving, by the debug server from the debug clients asynchronously during a debug session of the debuggee, a plurality of application-level messages; routing, by the message router in accordance with an application-level message passing protocol, the application-level messages among the debug clients, the debug administrator, and the back-end debugger, including providing distributed control of the back-end debugger to the debug clients with application-level messages routed to the back-end debugger; and returning, by the debug server to the debug clients in response to the application-level messages routed to the back-end debugger, client-specific debug results.

From the perspective of the debug clients, collaborative software debugging in accordance with embodiments of the present invention includes presenting, by each debug client to a user of the debug client, a client-specific GUI, the client-specific GUI providing a client-specific display of a debug session of the debuggee; detecting, by each debug client, user input through the client-specific GUI; generating, by each debug client in dependence upon the detected user input, one or more application-level messages; sending, by each debug client, the application-level messages to the debug server; receiving, by each debug client responsive to the application-level messages, client-specific debug results; and displaying, by each debug client in the client-specific GUI, the client-specific debug results.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a distributed system in which collaborative software debugging is carried out according to embodiments of the present invention.

FIG. 2 sets forth an example client-specific graphical user interface (GUI) presented to a user of a debug client in accordance with embodiments of the present invention.

FIG. 3 sets forth a flowchart illustrating an exemplary method of collaborative software debugging in a distributed system in accordance with embodiments of the present invention.

FIG. 4 sets forth a sequence diagram illustrating a further exemplary method of collaborative software debugging in accordance with embodiments of the present invention in which a debug client requests to join a debug session.

FIG. 5 sets forth a sequence diagram illustrating a further exemplary method of collaborative software debugging in accordance with embodiments of the present invention in which a debug client requests to leave a debug session.

FIG. 6 sets forth a sequence diagram illustrating a further exemplary method of collaborative software debugging in accordance with embodiments of the present invention in which a debug client requests to distribute data other debug clients.

FIG. 7 sets forth a sequence diagram illustrating a further exemplary method of collaborative software debugging in accordance with embodiments of the present invention in which a debug client requests to issue a command to the back-end debugger.

FIG. 8 sets forth a sequence diagram illustrating a further exemplary method of collaborative software debugging in accordance with embodiments of the present invention in which a debug client requests to establish an event notification with the back-end debugger.

FIG. 9 sets forth a sequence diagram illustrating a further exemplary method of collaborative software debugging in accordance with embodiments of the present invention in which a debug client requests to register a group of debug clients.

FIG. 10 sets forth a flowchart illustrating a further exemplary method of collaborative software debugging in a distributed system in accordance with embodiments of the present invention.

FIG. 11 sets forth a flowchart illustrating a further exemplary method of collaborative software debugging in a distributed system in accordance with embodiments of the present invention.

FIG. 12 sets forth a flowchart illustrating a further exemplary method of collaborative software debugging in a distributed system in accordance with embodiments of the present invention.

### DETAILED DESCRIPTION OF EXEMPLARY EMBODIMENTS

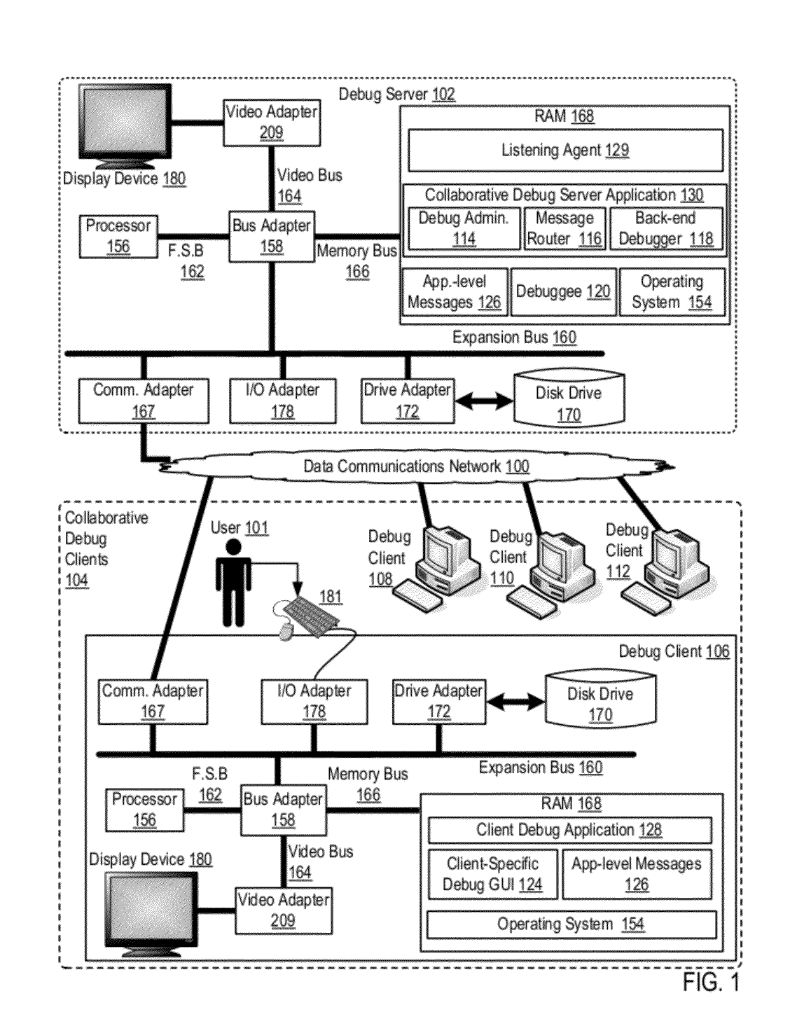

Exemplary methods, apparatus, and products for collaborative software debugging in a distributed system in accordance with the present invention are described with reference to the accompanying drawings, beginning with FIG. 1. FIG. 1 sets forth a network diagram of a distributed system in which collaborative software debugging is carried out according to embodiments of the present invention. The term ‘debug,’ and its variations—debugged, debugging, and so on—as used in this specification generally refers to a methodical process of finding and reducing the number of bugs, or defects, in a computer program, that is, in source code of the computer program. Debugging may also be carried out to produce other results—decrease source code size, increase efficiency of the source code, decrease memory use by the executed source code, and so on as will occur to readers of skill in the art. The source code of a software program or application being debugged is referred to in this specification as a ‘debuggee.’

The system of FIG. 1 is a distributed system. The term ‘distributed’ generally describes a system in which elements of the system are coupled for data communications through a data communications network, in many cases, a loosely-coupled data communications network. The distributed system of FIG. 1, for example, includes a debug server (102), a plurality of debug clients (104), and a data communications network (100). The debug server (102) in the example distributed system of FIG. 1 is coupled for data communications to the plurality of debug clients (104) through the data communications network (100). The term ‘distributed’ may also refer, as context requires, to the physical distribution of the debug clients (104). That is, each debug client (106, 108, 110, and 112) may physically remote from each of the other debug clients. Clients (106 and 108) may be located in different states in the United States, while client (110) may be located in China, and client (112) may be located in Japan. The plurality of clients (104) is ‘distributed’ physically in various locations.

In the distributed system of FIG. 1, each of the debug clients (106, 108, 110, and 112) and the debug server (102) is implemented as automated computing machinery, a computer. For clarity of explanation, not limitation, the components comprising the debug server (102) are similar to and bear the same numbers as corresponding components comprising each of the debug clients (104). Similar components may be described below with respect to only one of the debug server (102) or a debug client, but such descriptions applies to components of both the debug server and the debug client.

Each of the debug clients (106, 108, 110, 112) of FIG. 1 includes at least one computer processor (156) or ‘CPU’ as well as random access memory (168) (‘RAM’) which is connected through a high speed memory bus (166) and bus adapter (158) to processor (156) and to other components of the debug clients (106, 108, 110, 112). The debug server (102) includes similar components coupled in similar ways.

Stored in RAM (168) of each debug client (106, 108, 110, 112) is a client debug application (128), a module of computer program instructions that, when executed by the computer processor (156) of the debug client, causes the debug client to carry out client-side collaborative software debugging in accordance with embodiments of the present invention. The client debug application (128) of each debug client, say client (106) as an example, carries out client-side collaborative software debugging in accordance with embodiments of the present invention by: presenting, by the debug client (106) to a user (not shown) of the debug client (106), a client-specific GUI (124). In the example of FIG. 1, the client-specific GUI (124) is a client-specific display of a debug session of the debuggee. The phrase ‘client-specific’ as used here describes a GUI and display of a debug session that may differ from other debug clients' GUI and display of the same debug session. A debug session is a semi-permanent interactive information interchange between at least one debug client and a debug server for the purposes of a debugging a particular debuggee. A session is set up or established at a certain point in time, and torn down at a later point in time. An established communication session may involve more than one message in each direction.

The client debug application (128) of the debug client (106) may also detect user input through the client-specific GUI, generate, in dependence upon the detected user (100) input, one or more application-level messages (126), and send the application-level messages to the debug server (102). The phrase ‘application-level’ is used to describe messages that have meaning at a particular level in a data communications protocol model or framework. Consider, as one example of a data communications protocol model, the Open Systems Interconnection model that has seven layers, the application layer being the ‘highest’ and the physical layer being the lowest. Consider also, as another example, the TCP/IP model, which sets forth the application layer at the highest level and a link layer at the lowest level. The relative terms—higher and lower—describe a protocol's ‘closeness’ with regard to physical hardware (cables and the like) upon which data communications are passed. Each higher layer is a greater level of abstraction. In both models, the application layer or application-level is the highest level, farthest away from hardware and most abstracted layer. In the examples provided here, the application-level messages are abstracted from the data communications protocols used to transmit the data making up the application-level messages across one or many physical connections.

Detecting user (100) input through the client-specific GUI (124) in the example of FIG. 1 may include detecting user (100) input identifying a variable in source code of the debuggee (120). Generating one or more application-level messages (126) in the example of FIG. 1 may include generating a request to issue a command to the back-end debugger (118) to evaluate the variable. Such a request may be implemented as an application-level message (126) having a COMMAND REQUEST message type. The COMMAND REQUEST message may be sent to the debug server (102) to be passed along to the back-end debugger (118).

The term ‘server’ may, as context requires, refer to either or both of a server application or a computer upon which such a server application is executing. For clarity, the debug server (102) in the example of FIG. 1 is depicted and described as a computer upon which a server application executes.

Stored in RAM (168) of the debug server (102) is a listening agent (129), a module of computer program instructions that listens on a port for debug client requests where that port is well-known to the client. The listening agent (129) may also provide debug clients with a list of available collaborative debug server applications (130) or begin execution of a particular collaborative debug server application (130) upon request. A debug client, for example, may request that a particular type of collaborative debug server application be started for debugging a particular debuggee. The server (102) in the example of FIG. 1, may support simultaneous execution of several different debug server applications, each of which may debug separate debuggees. The listening agent may also provide to a requesting debug client, a port, socket, or other data communications identifier of the collaborative debug server application with which the requesting debug client is to communicate with during a debug session. That is, the listening agent (129) effectively brokers communications between a collaborative debug server application (130) and a debug client (104).

Also stored in RAM (168) of the debug server (102) is a collaborative debug server application (130), a module of computer program instructions that, when executed by the computer processor (156) of the debug server, causes the debug server (102) to carry out server-side collaborative software debugging in accordance with embodiments of the present invention. The collaborative debug server application (130) also includes a debug administrator (114), a message router (116), a back-end debugger (118), and a debuggee (120).

The debug administrator (114) is a module of computer program instructions that administers a collaborative debug session, administering client identifiers, registering and unregistering clients in a debug session, and so on. A back-end debugger (118) is an application that controls operation of another application—the debuggee (120)—for the purpose of testing execution of the debuggee. The source code of the debuggee may run on an instruction set simulator (ISS), a technique that allows great power in its ability to halt when specific conditions are encountered but which will typically be somewhat slower than executing the code directly on a processor for which the code is written. When execution of a program crashes or reaches a preset condition, a debugger typically displays the position in the source code at which the execution of the program crashed. A ‘crash’ occurs when the program cannot normally continue because of a programming bug. In addition to displaying a position in source code when execution of the source code crashes, debuggers also often offer other functions such as running a program step by step (single-stepping or program animation), stopping, breaking, or pausing the program to examine the current state, at some event or specified instruction by means of a breakpoint, and tracking the values of some variables.

The term ‘back-end’ is used here to indicate that the debugger (118) in the example of FIG. 1 is indirectly controlled by multiple clients. As explained below in detail, the back-end debugger (118) is controlled indirectly by multiple clients through use of an intermediary—the message router (116). From the perspective of the back-end debugger (118), the debugger is controlled by a single source, the message router (116). The message router, however, operates as intermediary between multiple debug clients and the debugger. The term ‘back-end’ may be further described by contrast to the term ‘front-end.’ Debugger front-ends are popular extensions to debugger engines that provide Integrated Development Environment (‘IDE’) integration, program animation, and visualization features, rather than console-based command line interfaces. The ‘front-end’ directly faces a client, in contrast to the ‘back-end’ debugger (118) in the example of FIG. 1, which interfaces indirectly with the clients through the message router (116).

The collaborative debug server application (130) carries out server-side collaborative software debugging in accordance with embodiments of the present invention by: receiving, by the debug server (102) from the debug clients (104) asynchronously during a debug session of the debuggee (120), a plurality of application-level messages (126); routing, by the message router (116) in accordance with an application-level message passing protocol, the application-level messages (126) among the debug clients, the debug administrator, and the back-end debugger. In routing the messages in the example of FIG. 1, the message router (116) provides distributed control of the back-end debugger (118) to the debug clients (104) with the application-level messages (126) routed to the back-end debugger (118). The debug server application (138) also returns, to the debug clients (104) in response to the application-level messages routed to the back-end debugger, client-specific debug results.

In embodiments such as those described above in which the debug client (106) detects user input indicating a variable in source code of the debuggee, generates, and sends a request to evaluate the variable, receiving a plurality of application-level messages may include receiving from a requesting debug client (106), the request to issue a command to the back-end debugger (118) to evaluate the variable, routing the application-level messages (126) may include issuing, to the back-end debugger (118), the command to evaluate the variable. The back-end debugger (118), responsive to the issued command, may then evaluate the variable and provide the results of the evaluation to the message router (116). Returning client-specific debug results in such embodiments may include returning the results of the evaluation to the requesting debug client (106).

Each debug client (106, 108, 110, 112), is also configured to receive the client-specific debug results as application-level reply messages (126) and display, in the client-specific GUI (180), the client-specific debug results. In embodiments in which the debug client (106) detects user (101) input indicating a variable in source code of the debuggee (120), generates, and sends a request to evaluate the variable, receiving client-specific debug results may also include receiving the results of the evaluation of the variable and displaying the client-specific debug results may also include displaying the results of the evaluation of the variable.

Also stored RAM (168) of the debug server (102) and debug clients (104) is an operating system (154). An operating system is a computer software component that is responsible for execution of applications programs and for administration of access to computer resources, memory, processor time, and I/O functions, on behalf of application programs. Operating systems useful in computers of a distributed system in which collaborative software debugging is carried out according to embodiments of the present invention include UNIX™, Linux™, Microsoft XP™, AIX™, IBM's i5/OS™, and others as will occur to those of skill in the art. The operating system (154), collaborative debug server application (130), debuggee (120), client debug application (128), client-specific debug GUI (124), and so on in the example of FIG. 1 are shown in RAM (168), but many components of such software typically are stored in non-volatile memory also, such as, for example, on a disk drive (170).

Each of the debug server (102) and debug clients (104) of FIG. 1 includes disk drive adapter (172) coupled through expansion bus (160) and bus adapter (158) to processor (156) and other components of the debug server (102) and debug clients (104). Disk drive adapter (172) connects non-volatile data storage to each of the debug server (102) and debug clients (104) in the form of disk drive (170). Disk drive adapters useful in computers that provide collaborative software debugging according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

Each of the example debug server (102) and debug clients (104) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. Each of the example debug server (102) and debug clients (104) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

Each of the example debug server (102) and debug clients (104) of FIG. 1 includes a communications adapter (167) for data communications with other computers and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers that provide collaborative software debugging according to embodiments of the present invention include modems for wired dial-up communications, Ethernet (IEEE 802.3) adapters for wired data communications network communications, and 802.11 adapters for wireless data communications network communications.

The arrangement of debug servers, debug clients, data communications networks, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

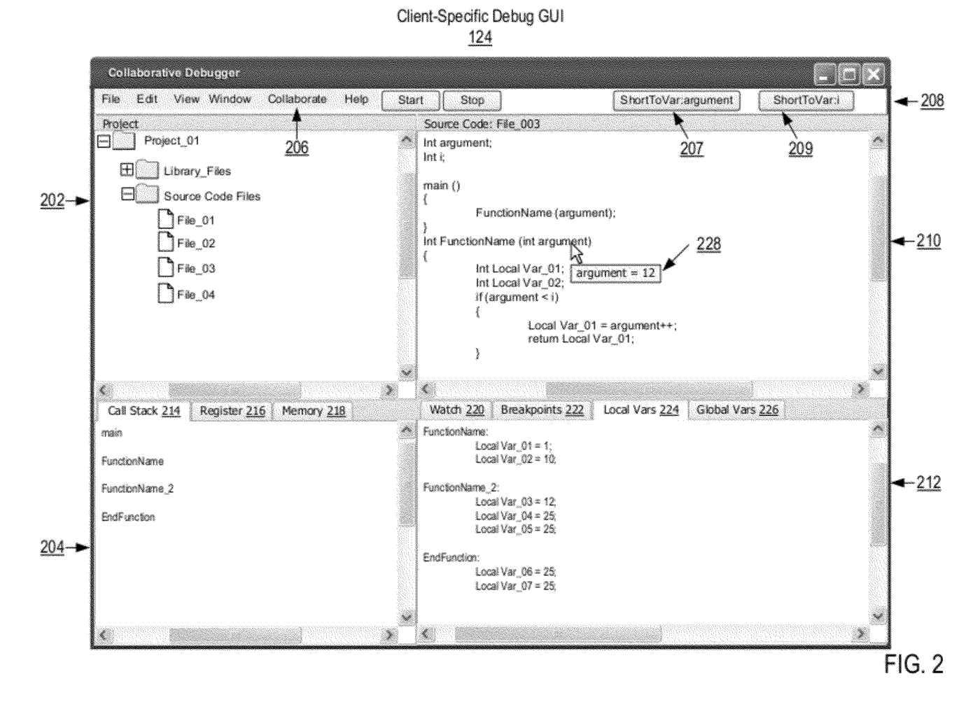

For further explanation, FIG. 2 sets forth an example client-specific GIU presented to a user of a debug client in accordance with embodiments of the present invention. The example GUI (124) of FIG. 2 provides an interface for a user of a debug client to effectively control, collaboratively with other client debuggers, the back-end debugger of a debug server. The example GUI (124) of FIG. 2 includes a menu bar (208), including a number of separate menus: a File menu, an Edit menu, a View menu, a Collaborate menu, and a Help menu. The Collaborate menu (206), when selected, may provide a user with various menu items that support collaborative debugging. In the GUI (124) of FIG. 2, the Collaborate menu may, for example, include a menu item for private or public variable evaluation. Selecting the private menu item may invoke a popup or other GUI window from which a variable or variables may be selected for private evaluation by a user. ‘Private’ as the term is used here means that the results of the evaluation are returned only to the client requesting the evaluation. ‘Public’ evaluation by contrast means that the results of the evaluation may be presented to other clients—a predefined group, one or more clients selected in real-time during the selection of the variable to evaluation, or all clients registered in the debug session.

The Collaborate menu (206) may also include an option to create a GUI shortcut for a location of a variable in source code and publish (make public) that shortcut to other clients. A ‘location’ in source code may be specified in various ways including, for example, by source code file name, line number, and thread identifier. A GUI shortcut to a location in source code of a variable, when invoked by a user through user input such as a mouse-click, changes the focus or view of the source code in such a way as to display the line in source code—the location—that include the variable. Such shortcuts, may be created and implemented in various ways in a GUI. One such way included in the example GUI (124) of FIG. 2 is as a GUI buttons (207 and 208). GUI button (208) is a shortcut to a predefined location of a variable named ‘argument’ and a GUI button (208) is a shortcut to a predefined location of a variable named ‘i.’

In the example GUI (124) of FIG. 2, a user has operated a mouse such that a mouse pointer is hovering over a variable. The GUI in the example of FIG. 2, is configured detect user input identifying a variable in source code of the debuggee by detecting a mouse-over, also called a hover-over, of the variable in source code of the debuggee. In this example, upon a mouse-over of the variable named ‘argument,’ a request is sent, by the debug client presenting the GUI (124) of FIG. 2, to a debug server to issue a command to a back-end debugger to evaluate the variable, the debug client receives results of the evaluation, and a pop-up text box (228) is displayed that includes the results. Readers of skill in the art will recognize that a mouse-over is but one way among many in which a GUI, or debug client presenting the GUI, may detect user input identifying a variable to evaluate. Other possible ways include: detecting a mouse click, left or right-click, on the variable in source code of the debuggee; detecting a selection of the text of variable, coupled with an invocation of a GUI button presented in the GUI (124) for the purpose of evaluating variables, or detecting a selection of the text of variable in source code, followed by a predefined keyboard shortcut, and so on.

The example GUI (124) of FIG. 2 also includes several independent portions—called panes (as in ‘window panes’) for clarity of explanation—a project pane (202), a source code pane (210), and two separate data panes (204, 212). Project pane (202) presents the files and resources available in a particular software development project. Source code pane (210) presents the source code of debuggee. The data panes (204, 212) present various data useful in debugging the source code. In the example of FIG. 2, data pane (204) includes three tabs, each of which presents different data: a call stack tab (214), a register tab (214), and a memory tab (218). Data pane (212) includes four tabs: a watch list tab (220), a breakpoints (222) tab, a local variable tab (224), and a global variable tab (226).

The debug GUI of each debug client in a distributed system for which collaborative software debugging is carried out in accordance with embodiments of the present invention is client-specific, meaning any one debug GUI may be configured differently, displayed differently, or operate differently, than any other debug client's GUI, while all debug clients collaboratively control the same, single back-end debugger of a debug server during the same debug session of the same debuggee. One debug GUI may display the source code at one location (line number) while another debug GUI displays the source code at another location; one debug GUI displays a call stack of one thread, while another debug GUI displays a call stack of another thread; one debug GUI displays evaluation results of one variable, while another debug GUI displays evaluation results of another variable; and so on as will occur to readers of skill in the art. The example client-specific debug GUI (124) of FIG. 2 provides a client-specific display of debugging along with collaborative, or ‘distributed,’ control of the debugger, rather than all debug clients displaying only the same GUI as a single master debug client, where the master client has absolute, not collaborative, control over the debugger until passing that control to another client.

The GUI items, menus, window panes, tabs, and so on depicted in the example client-specific GUI (124) of FIG. 2, are for explanation, not for limitation. Other GUI items, menu bar menus, drop-down menus, list-boxes, window panes, tabs, and so on as will occur to readers of skill in the art may be included in client-specific GUIs presented by debug clients in a distributed system in which collaborative software debugging is carried out in accordance with embodiments of the present invention.

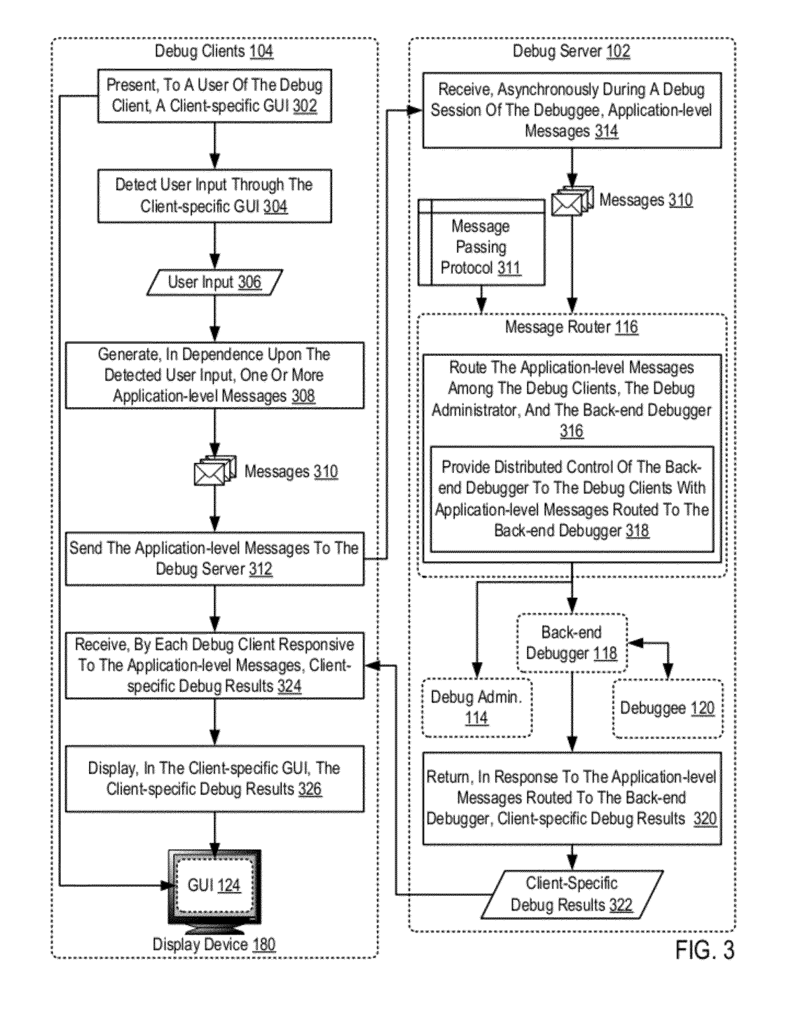

For further explanation, FIG. 3 sets forth a flowchart illustrating an exemplary method of collaborative software debugging in a distributed system in accordance with embodiments of the present invention. In the method of FIG. 3, the distributed system includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118), and a debuggee (120).

The method of FIG. 3 includes presenting (302), by each debug client (104) to a user (101 on FIG. 1) of the debug client (104), a client-specific GUI (124). In the method of FIG. 3, each debug client's (104) client-specific GUI (124) is implemented as a client-specific display of a debug session of the debuggee (120). Presenting (302) a client-specific GUI (124) may be carried out by rendering the GUI (124) on a display device (180), with each debug client operating semi-independently from other debug clients in presenting the GUI (124). As mentioned above, each GUI (124) may be display different debugging attributes even though each of the debug clients presenting the GUI (124) are participating in the same debug session of the same debuggee.

The method of FIG. 3 also includes detecting (304), by each debug client (104), user (101 on FIG. 1) input (306) through the client-specific GUI (124). Detecting (304), user input (306) through the client-specific GUI (124) may be carried out in various ways including, for example, detecting mouse-overs, detecting keyboard keystrokes, detecting keyboard shortcuts, detecting explicit commands entered into a field presented to receive such commands, detecting selection of drop-down menu items, detecting mouse-clicks on GUI items, such as GUI buttons, and so on.

The method of FIG. 3 also includes generating (308), by each debug client (104) in dependence upon the detected user input (306), one or more application-level messages (310) and sending (312), by each debug client (104), the application-level messages (310) to the debug server (102). Generating (308) one or more application-level messages (310) may be carried out by identifying, from message generation rules, a message type, and creating application-level messages of the message type that includes at least an identification of a sender, a recipient, and the message type. Examples of message types are described below in detail and include a JOIN message type, a LEAVE message type, a DISTRIBUTE REQUEST message type, a COMMAND REQUEST message type, and EVENT REQUEST message type, a REGISTER GROUP message type, a CONFIRMATION REPLY message type, a REQUEST REPLY message type, and an EVENT REPLY message type.

The method of FIG. 3 also includes receiving (314), by the debug server (102) from the debug clients (104) asynchronously during a debug session of the debuggee (120), the application-level messages (310). Receiving (314) the application-level messages (310) may be carried out by listening on a well-known data communications socket, upon which application-level messages (310) of the kind sent by the debug clients (104) are expected to be received.

The method of FIG. 3 also includes routing (316), by the message router (116) in accordance with an application-level message passing protocol (311), the application-level messages (310) among the debug clients (104), the debug administrator (114), and the back-end debugger (118). In the method of FIG. 3, routing (316) the application-level messages (310) includes providing (318) distributed control of the back-end debugger (118) to the debug clients (104) with application-level messages (310) routed to the back-end debugger (118). That is, the messages routed to the back-end debugger—message received from any of the debug clients at any time during the debug session of the debuggee—control operation of the back-end debugger. The application-level messages control debugging of the debugging.

The method of FIG. 3 also includes returning (320), by the debug server (102) to the debug clients (104) in response to the application-level messages (310) routed to the back-end debugger (118), client-specific debug results (322). Returning (320), client-specific debug results (322) to the debug clients (104) may be carried out by generating, by the debug server or more specifically, the message router (116), one or more application-level messages forming a reply or replies that include the results and sending the replies to the debug clients via the data communications network (100 on FIG. 1).

The method of FIG. 3 also includes receiving (324), by each debug client (104) responsive to the application-level messages (310), client-specific debug results (322) and displaying (326), by each debug client in the client-specific GUI (124) on a display device (180), the client-specific debug results (322).

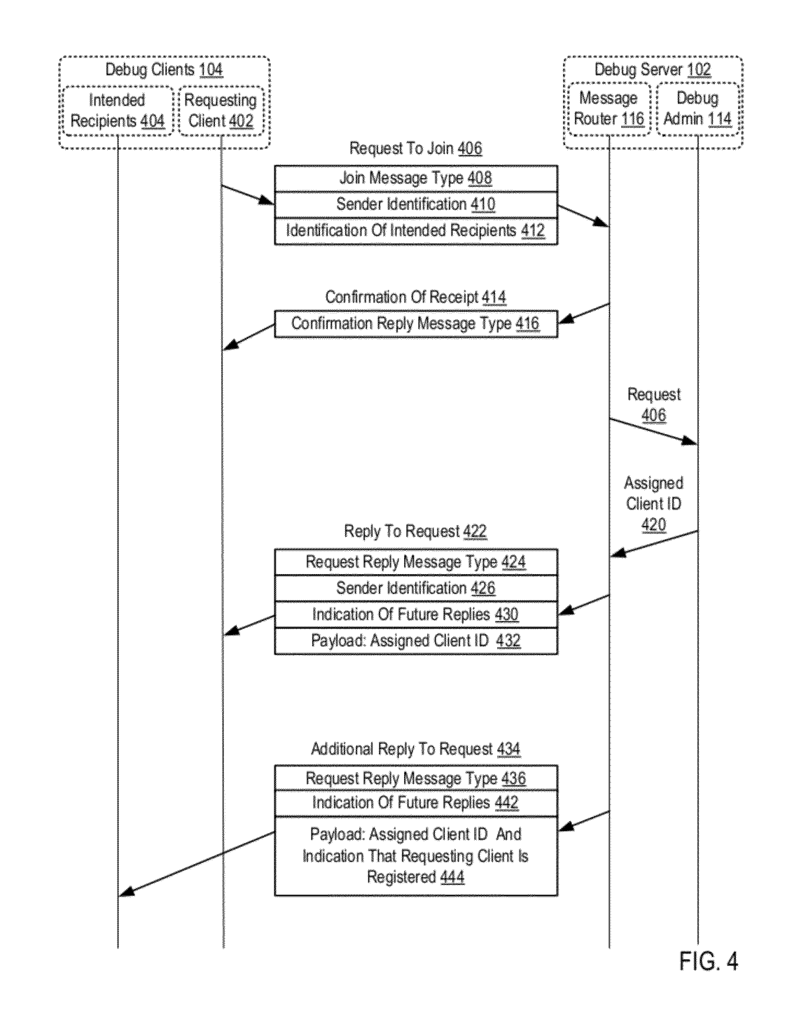

As described above, once received by a debug server (102) from a debug client, an application-level message (310) in the example of FIG. 3, the application-level message (310) is routed to one of a back-end debugger (118), a debug administrator (114), or one or more other debug clients (104) in dependence upon an application-level message passing protocol (311). For further explanation of such a message passing protocol useful in distributed systems in which collaborative software debugging is carried out in accordance with embodiments of the present invention, FIGS. 4-9 set forth various sequence diagrams that illustrate message passing in accordance with the message passing protocol. FIG. 4, therefore, sets forth a sequence diagram illustrating a further exemplary method of collaborative software debugging in accordance with embodiments of the present invention in which a debug client requests to join a debug session. The method of FIG. 4 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 4, illustrated in a sequence diagram rather than a flowchart, is similar to the method of FIG. 3 in that the method of FIG. 4 depicts a debug client—the requesting client (402) of FIG. 4—generating (308 on FIG. 3) one or more application-level messages (310 on FIG. 3). In the example of FIG. 4, the requesting client (402) generates a request (406) to join the debug session. In the method of FIG. 4, the request is implemented as an application-level message having a JOIN REQUEST message type (408), an identification (410) of the sender of the request to join (such as an IP address, Socket Number, or port number), and an identification (412) of one or more intended recipients. Such intended recipients may include the sender, all other debug clients registered in the session, or some subset of debug clients registered in the session. As explained below in more detail, an identification of an intended recipient in the example request (406) to join is not an identification of a recipient of the request itself—the debug server (102) is the recipient of the request itself—instead, the identification of an intended recipient in the request join actually identifies a recipient of future replies to the request. The request (406) may also include a message identifier, uniquely identifying the request. Responses to the request may include such a message identifier so that debug clients may identify the request to which the response relates.

In the example of FIG. 4, sending (312 on FIG. 3), by the requesting client (402), the application-level messages (310 on FIG. 3) to the debug server (102), includes sending the request (406) to join the debug session and receiving (314 on FIG. 3) the application-level messages (310 on FIG. 3) includes receiving, by the debug server (102) and, more specifically, the message router (116), the request (406) to join the debug session.

The method of FIG. 4 also includes sending, by the message router to the requesting debug client (402), in response to receiving the request (406), a confirmation (414) of receipt of the request (406) to join, the confirmation implemented as an application-level message having a CONFIRMATION REPLY message type (416). The confirmation may also include a message identifier that uniquely identifies the request (406) for which the confirmation reply is confirming receipt. The requesting debug client (402) in the example of FIG. 4 receives the confirmation (414). If the requesting debug client (402) does not receive a confirmation (414) after a predefined amount of time, the requesting client (402) may resend the request (406).

After receiving the request (406), the message router (116) routes (316 on FIG. 3) the application-level messages by forwarding the request (406) to join the debug session to the debug administrator (114). The debug administrator (114) then registers the requesting debug client (402) in the debug session and assigns the requesting debug client (402) a client identifier (420) unique to the debug session. After assignment a client identifier may be used in message passing among the debug clients, debug server, and debug administrator to identify a recipient of a message, to identify a sender of a message, and so on. The debug administrator (114) may maintain a list, or other data structure, of available client identifiers and a table, or other data structure, of assigned client identifier. A table of assigned client identifiers may include a plurality of entries, with each entry representing a single client. Each entry in such a table may associate a client identifier with another identification of the client—a MAC (Media Access Control) address, an IP (Internet Protocol) address, a socket identifier, and so on as will occur to readers of skill in the art.

After assigning the client identifier (420), the debug administrator (114) may return, to the message router (116), the assigned client identifier (420) and the message router (116) may send the client identifier (420) along to the requesting client (402) in a reply (422) to the request (406) to join the debug session. In the example of FIG. 4, the reply (422) is implemented as an application-level message having a REQUEST REPLY message type (424), an indication (430) of future replies responsive to the request (406) to join, an identification (426) of sender of the reply, and a payload (432) that includes the assigned client identifier (420). In the method of FIG. 4, the requesting client (402) receives the reply (422).

In the method of FIG. 4, the message router (116) also sends, to debug clients (404) identified as intended recipients in the request (406) to join, an additional reply (434) to the request (406) to join and the debug clients (404) receive the additional reply (434). In the method of FIG. 4, the additional reply (434) is implemented as an application-level message having a REQUEST REPLY message type (436), an indication (442) of future replies responsive to the request to join, and a payload (444) that includes the assigned client identifier (420) and an indication that the requesting debug client is registered in the debug session.

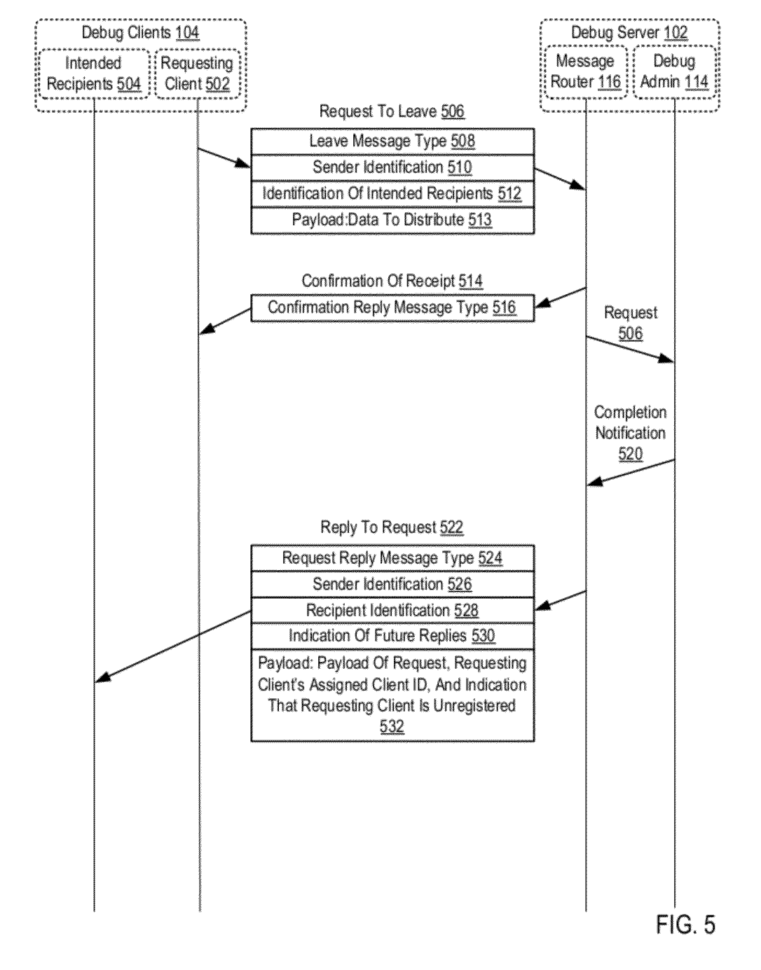

For further explanation, FIG. 5 sets forth a sequence diagram illustrating a further exemplary method of collaborative software debugging in accordance with embodiments of the present invention in which a debug client requests to leave a debug session. The method of FIG. 5 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 5 includes generating, by a requesting debug client (502), a request (506) to leave the debug session and receiving the request (502) to leave the debug session by the message router (116). In the example of FIG. 5, the request (506) is implemented as an application-level message having a LEAVE REQUEST message type (508), a sender's identification (510), an identification (512) of one or more intended recipients, and a payload (513) to distribute to the intended recipients upon leaving the debug session.

The method of FIG. 5 continues by the message router (116) sending, to the requesting debug client (502), a confirmation of receipt of the request (506) to leave and receiving by the requesting debug client (502) the confirmation. The confirmation in the example of FIG. 5 may be implemented as an application-level message having a CONFIRMATION REPLY message type (516).

The method of FIG. 5 also includes by forwarding the request (506) to leave the debug session to the debug administrator, unregistering, by the debug administrator (114), the requesting debug client from the debug session, including unassigning the requesting debug client's (502) client identifier, and returning, to the message router (116) a completion notification (520).

The message router (116) in the example of FIG. 5 then sends, to debug clients (504) identified as intended recipients in the request (502) to leave, a reply (522) to the request to leave and receiving, by the debug clients (504) identified as intended recipients, the reply (522) to the request to leave. The reply (522) may be implemented as an application-level message having a REQUEST REPLY message type (524), an identification (526) of a sender of the message, an identification of the recipient of the message (528), an indication (530) of future replies responsive to the request (506) to leave, and as a payload (542) of the reply, the payload (513) included in the request (513) to leave.

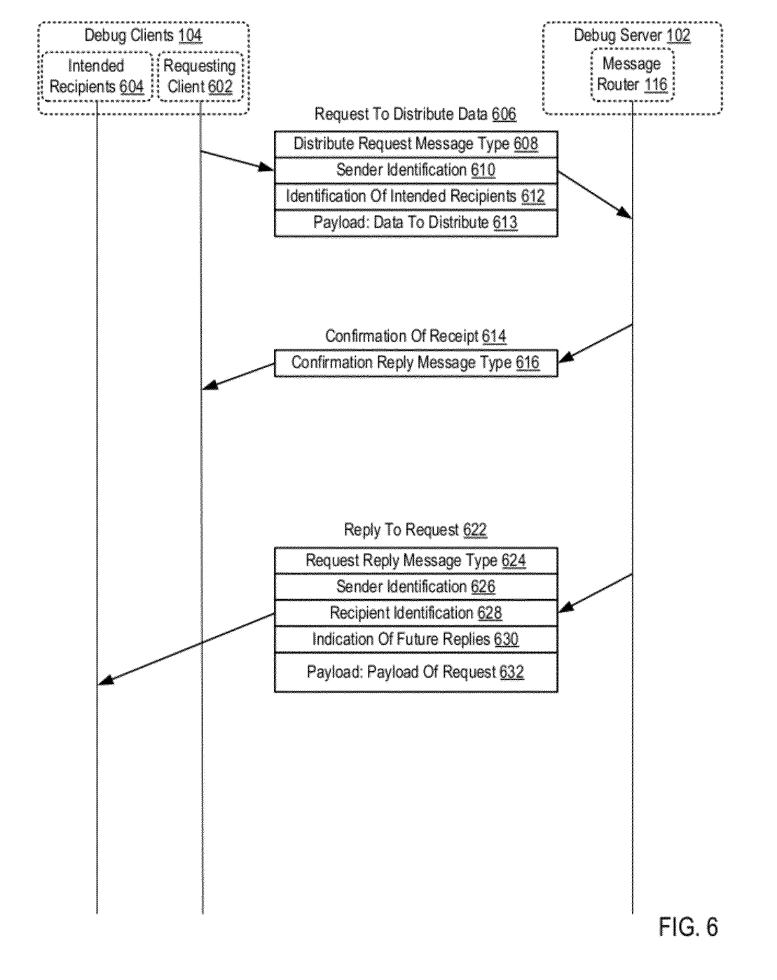

For further explanation, FIG. 6 sets forth a sequence diagram illustrating a further exemplary method of collaborative software debugging in accordance with embodiments of the present invention in which a debug client requests to distribute data other debug clients. The method of FIG. 6 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 6 includes generating, by a requesting debug client (602), a request (606) to distribute data (613) to debug clients registered in the debug session, sending, to the debug server, the request (606), and receiving, by the message router (116), the request (606). In the example of FIG. 6, the request (606) to distribute data may be implemented as an application-level message having a DISTRIBUTE REQUEST message type (608), an identification of a sender (610) of the message, an identification (612) of one or more intended recipients (604), and a payload that includes data (613) to distribute to the intended recipients.

Responsive to receiving the request (606), the message router (116) in the example of FIG. 6, sends, to the requesting debug client (602), a confirmation of receipt of the request (606) to distribute data and the requesting debug client (602) receives the confirmation (614). In the example of FIG. 6, the confirmation may be implemented as an application-level message having a CONFIRMATION REPLY message type (616).

The method of FIG. 6 continues by sending, by the message router (116) to debug clients identified as intended recipients (602) in the request (606) to distribute data, a reply (622) to the request (606) to distribute data, and receiving, by the debug clients identified as intended recipients (602), the reply (622). In the example of FIG. 6, the reply (622) may be implemented as an application-level message having a REQUEST REPLY message type (624), an identification of a sender of the message (626), an identification (628) of a recipient of each message, an indication (630) of future replies responsive to the request (606) to distribute data, and a payload (632). The payload (632) of the reply (622) includes the data to distribute originally included in the request (606). That is, the payload (632) of the reply (622) is the payload (613) included in the request (606) to distribute data.

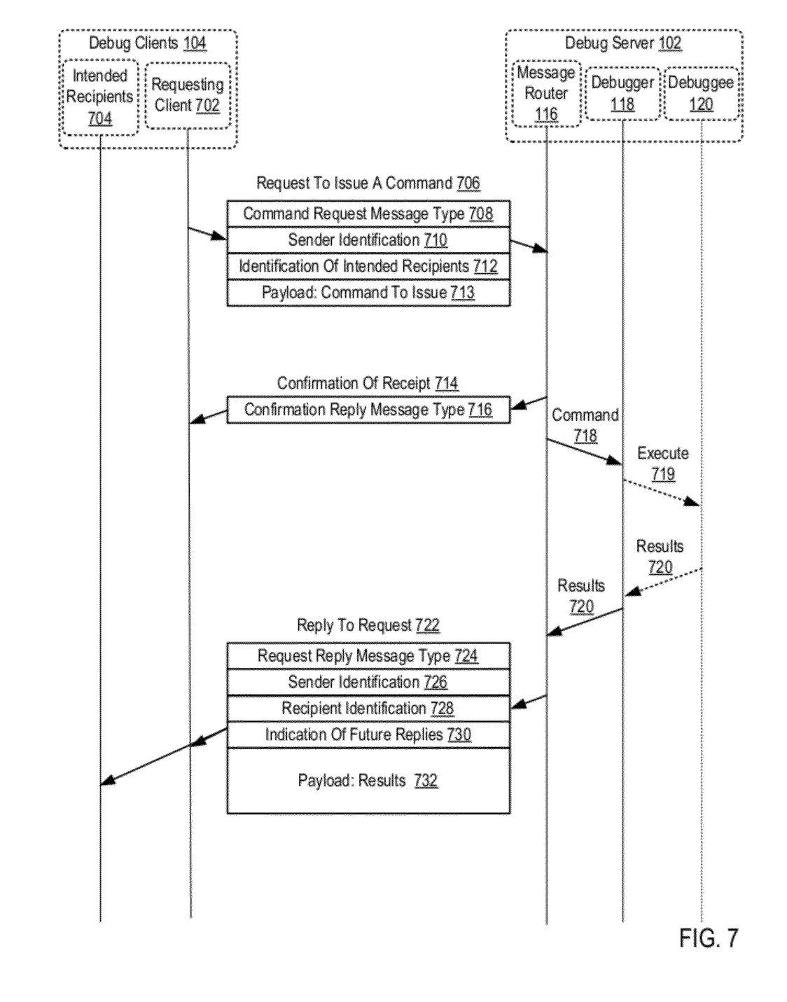

FIG. 7 sets forth a sequence diagram illustrating a further exemplary method of collaborative software debugging in accordance with embodiments of the present invention in which a debug client requests to issue a command to the back-end debugger. The method of FIG. 7 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 7 includes generating, by a requesting debug client (702), a request (706) to issue a command (718) to the back-end debugger (118), sending the request (706) to the debug server (102), and receiving the request (722) by the message router (116). In the example of FIG. 7, the request (706) may be implemented as an application-level message having a COMMAND REQUEST message type (708), an identification (710) of a sender of the message, an identification (712) of one or more intended recipients of results of executing the command, and a payload (713). The payload (713) of the request (706) in the example of FIG. 7 includes the command to issue to the back-end debugger. The command may be a text command to be entered into a command line interface of the back-end debugger. Examples of commands which may be issued to a back-end debugger through a command line interface, may include: backtrace, step, next, until, continue, clear, help, info breakpoints, info watchpoints, info registers, info threads, and so on as will occur to readers of skill in the art. These are merely some of many possible commands which may be issued to a debugger.

The method of FIG. 7 continues by sending, by the message router (116) to the requesting debug client (702), a confirmation (714) of receipt of the request (706) to issue the command (718) and receiving the confirmation by the requesting debug client (702). In the example of FIG. 7, the confirmation (714) is implemented as an application-level message having a CONFIRMATION REPLY message type (716).

The method of FIG. 7 also includes routing the request (706) to the back-end debugger (118) by issuing the command (718) to the back-end debugger (118) by the message router (116). The method of FIG. 7 continues by the back-end debugger, executing the issued command (718). For some commands, executing the command (718) causes the back-end debugger (118) to initiate execution (719) of the debuggee, for debugging purposes, monitor the execution of the debuggee, and gather results (720) of the execution. For other commands, the command may be executed entirely by the back-end debugger without initiating execution of the debuggee.

After executing the issued command in the example of FIG. 7, the back-end debugger (118) returns to the message router (116) results (720) of the execution of the issued command, the message router receives the results (718). The nature of the results (720) of the execution depend upon the type of command (718) executed by the back-end debugger. A command to evaluate a variable for example, may return as little as an integer, while a command to step into execution of the debuggee may return significantly more information—variable values, register values, memory values, line number, source code file name, and thread number and so on. The results (720), once received by the requesting client (702) may be used to control the client-specific GUI, changing the information displayed on the GUI.

The message router (116) in the example of FIG. 7 sends, to each of the requesting debug client (702) and debug clients (704) identified as intended recipients in the request (706) to issue the command (718), a reply (722) to the request to issue the command and the debug clients (704) and requesting client (702) receive the reply (722). In the example of FIG. 7, the reply (722) may be implemented as an application-level message having a REQUEST REPLY message type (724), an identification (726) of a sender of the message, an identification (728) of a recipient of the message, an indication (730) of future replies responsive to the request (706) to issue the command, and a payload (732) that includes the results (720) of executing the issued command.

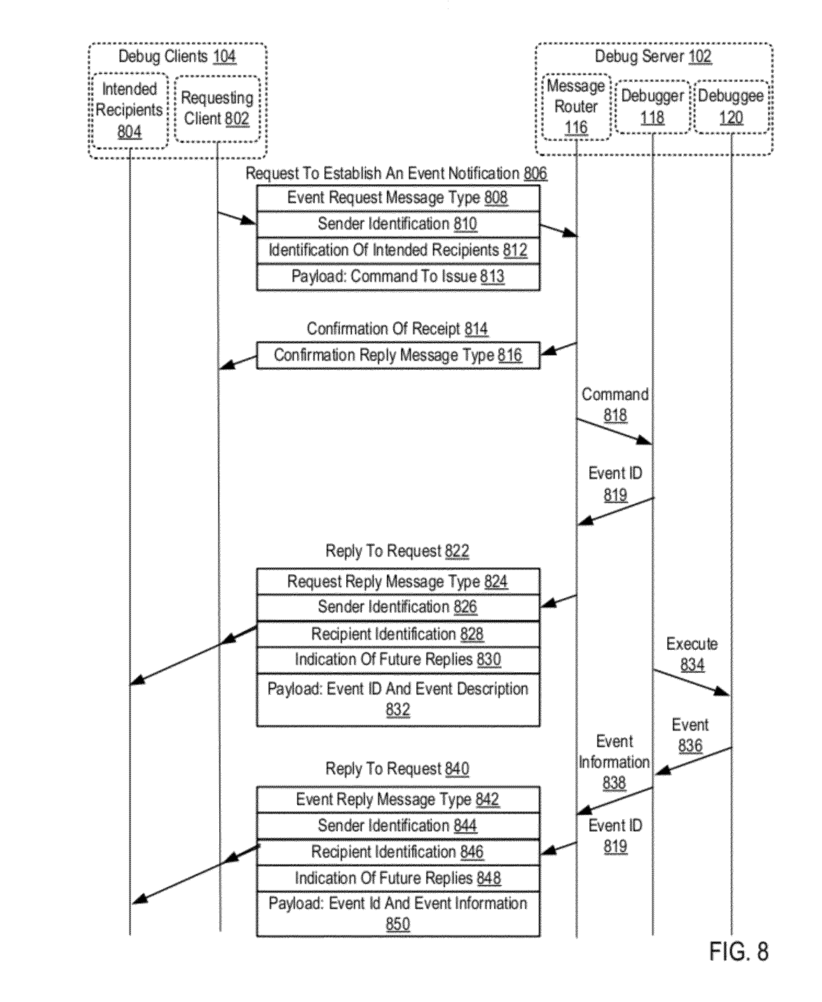

FIG. 8 sets forth a sequence diagram illustrating a further exemplary method of collaborative software debugging in accordance with embodiments of the present invention in which a debug client requests to establish an event notification with the back-end debugger. The method of FIG. 8 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 8 includes generating, by a requesting debug client (802), a request (806) to establish, with the back-end debugger, an event notification associated with a particular event during the debug session, sending, to the debug server (102), the request (806), and receiving, by the message router, the request (806). In the example of FIG. 8, the request (806) may be implemented as an application-level message having an EVENT REQUEST message type (806), an identification (810) of a sender of the message, an identification (812) of one or more intended recipients of notifications of the of the event, and a payload (813) that includes a command (818) to issue to the back-end debugger (118) to establish the event notification. An event is a predefined occurrence during execution of debuggee. Such an event may include encountering a breakpoint, a watchpoint, a catchpoint, or the like. A breakpoint is a specification of a source code location at which a debuggee will pause or stop execution. A watchpoint is a breakpoint configured to pause or stop execution of the debuggee when a value of a particular expression changes. A catchpoint is another type of breakpoint configured to pause or stop execution of the debuggee when a specified event occurs such as the throwing of an exception or a load of a library, and so on.

The method of FIG. 8 also includes sending, by the message router (116) to the requesting debug client, a confirmation (814) of receipt of the request (806) to establish the event notification and receiving, by the requesting client (802), the confirmation. In the example of FIG. 8, the confirmation may be implemented as an application-level message having a CONFIRMATION REPLY message type (816).

The method of FIG. 8 also includes routing the request (806) to the back-end debugger by issuing, to the back-end debugger, the command (818) to establish the event notification. The back-end debugger (118) in the example of FIG. 8 may then execute the issued command including establishing the event notification associated with the particular event and assigning the event notification an event identifier (819). Establishing a notification of such an event may, for example, include setting and enabling a breakpoint, watchpoint, or catchpoint at a particular location in the source code specified by the requesting debug client (802) in the request (806).

The method of FIG. 8 includes returning, by the back-end debugger (118) to the message router (116), the event identifier (819), sending, by the message router (116) to each of the requesting debug client (802) and debug clients (804) identified as intended recipients in the request (806) to establish the event notification, a reply (822) to the request to establish the event notification, and receiving the reply (822) by the requesting client (802) and the intended recipients (804). In the example of FIG. 8, the reply may be implemented as an application-level message having a REPLY REQUEST message type (824), a sender identification (826), a recipient identification (828), an indication of future replies (830), and a payload (832) that includes the event identifier (832) and optionally a description of the event notification.

The method of FIG. 8 also includes: executing (834) the debuggee (120) by the back-end debugger (118); encountering, during the debug session, the particular event (836) associated with the event notification; providing, by the back-end debugger (118) to the message router (116), information (838) describing the particular event and the event identifier (819); and receiving, by the message router from the back-end debugger, the information (838) describing the particular event and the event identifier (819).

The method of FIG. 8 continues with the message router (116) sending, to each of the requesting debug client (802) and debug clients (804) identified as intended recipients in the request (806) to establish the event notification, a reply (840) to the request to establish the event notification and receiving by the requesting client (802) and by the intended recipients (804), the reply (811). In the example of FIG. 8, the reply (811) to the request (806) to establish the event notification may be implemented as an application-level message having an EVENT REPLY message type (842), a sender identification (844), a recipient identification (846), an indication (848) of future replies responsive to the request establish the event notification, and a payload (850) that includes the information (838) describing the particular event and the event identifier (819).

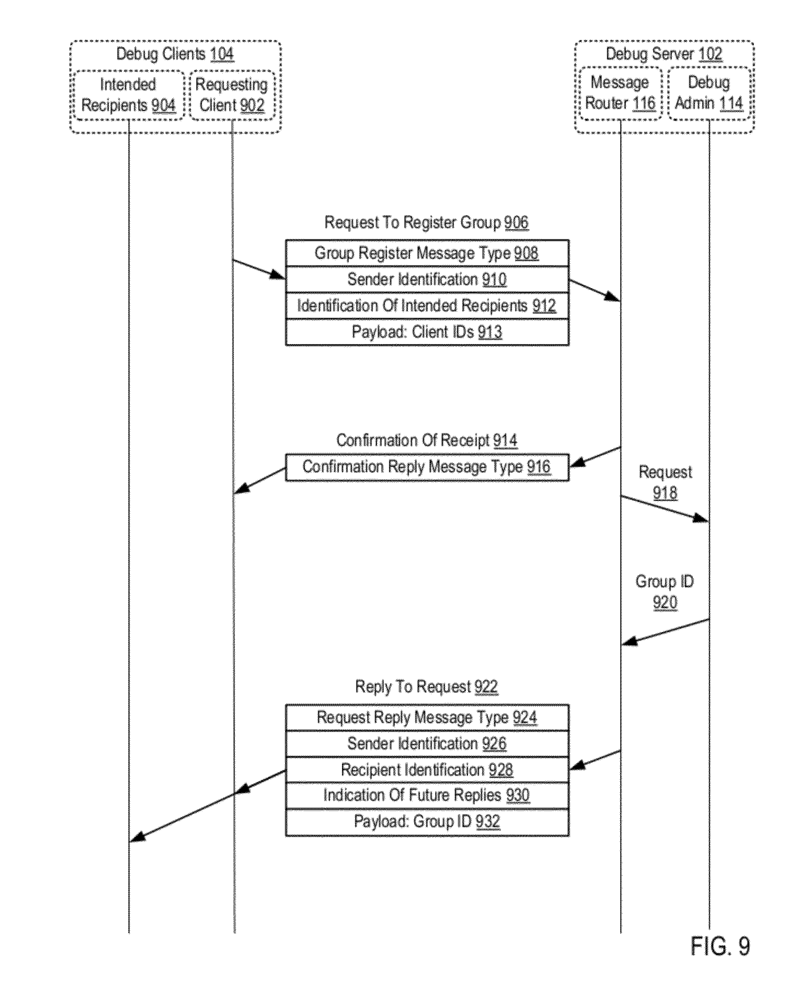

FIG. 9 sets forth a sequence diagram illustrating a further exemplary method of collaborative software debugging in accordance with embodiments of the present invention in which a debug client requests to register a group of debug clients. Once a group of debug clients is registered, as explained below, a group identifier is assigned to the group. Rather than listing out multiple client identifiers application-level messages intended for multiple recipients, debug clients may use a group identifier instead. Group identifiers may also be used for privacy or security in debugging—associating a breakpoint, variable, or portion of source code, for example, with a group identifier of a particular group and providing access only to members of the particular group.

The method of FIG. 9 is carried out in a distributed system similar to the system of FIG. 1 which includes a debug server (102), a plurality of debug clients (104), and a data communications network (100 on FIG. 1). The debug server (102) is coupled for data communications to the plurality of debug clients (104) through the data communications network (100). The debug server (102) further includes a debug administrator (114), a message router (116), a back-end debugger (118 on FIG. 1), and a debuggee (120 on FIG. 1).

The method of FIG. 9 includes generating, by a requesting debug client (902), a request (906) to register a group of debug clients, sending the request (906) to the debug server (102), and receiving the request (906) by the message router (116). In the example of FIG. 9, the request (906) may be implemented as an application-level message having a GROUP REGISTER REQUEST message type (908), a sender identification (910), an identification (912) of one or more intended recipients, and a payload (913) that includes client identifiers of a plurality of debug clients to include in the group of debug clients.

The method of FIG. 9 also includes sending, by the message router (116) to the requesting debug client (902), a confirmation (914) of receipt of the request (906) to register the group and receiving the confirmation (914) by the requesting debug client (902). In the example of FIG. 9, the confirmation (914) may be implemented as an application-level message having a CONFIRMATION REPLY message type (916).

The method of FIG. 9 also includes routing the request (906) to the debug administrator (114) and registering, by the debug administrator (114), the group of debug clients, including assigning the group of debug clients a group identifier (920) unique within the debug session. In the method of FIG. 9, the debug administrator (114) returns the group identifier (920) to the message router (116).

The method of FIG. 9 continues by sending, by the message router (116) to each of the requesting debug client (902) and the debug clients identified as intended recipients (904) in the request (906) to register the group of debug clients, a reply (922) to the request (906) and receiving by the requesting debug client (902) and the intended recipients (904), the reply (922). In the example of FIG. 9, the reply (922) may be implemented as an application-level message having a REQUEST REPLY message type (924), a sender identification (926), a recipient identification (928), an indication (930) of future replies responsive to the request to register the group of debug clients, and a payload (932) that includes the assigned group identifier (920).

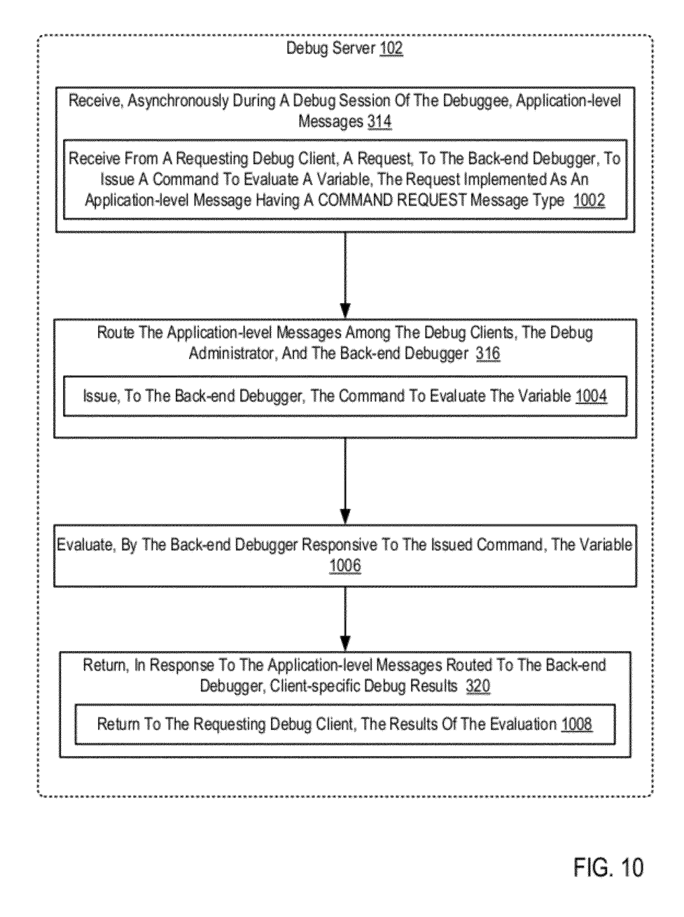

FIG. 10 sets forth a flowchart illustrating a further exemplary method of collaborative software debugging in a distributed system, such as the example system depicted in FIG. 1, in accordance with embodiments of the present invention. FIG. 10 is directed primarily to operation of the debug server, rather than the debug clients, in carrying out collaborative debugging in accordance with embodiments of the present invention. FIG. 10 is similar to the method of FIG. 3 in that the method of FIG. 10 includes receiving (314) a plurality of application-level messages, routing (316) the application-level messages, and returning (320) client-specific debug results.

The method of FIG. 10 differs from the method of FIG. 3, however, in that in the method of FIG. 10, receiving (314) a plurality of application-level messages includes receiving (1002) from a requesting debug client, a request, to issue a command to the back-end debugger to evaluate a variable, the request including an application-level message having a COMMAND REQUEST message type.

In the method of FIG. 10, routing (316) the application-level messages is carried out by issuing (1004), to the back-end debugger, the command to evaluate the variable. Issuing (1004) the command to the back-end debugger may be carried out by providing text to a command line interface made available by the back-end debugger to the message router. Such text may be any of the following example text commands: print variable-name; p variable-name; p file-name::variable-name; p ‘file-name’::variable-name, where ‘variable-name’ is the name of the variable.

The method of FIG. 10 also includes evaluating (1006), by the back-end debugger responsive to the issued command, the variable and providing (1008), to the message router, the results of the evaluation. In the method of FIG. 10, returning (320) client-specific debug results is carried out by returning (1008), to the requesting debug client, the results of the evaluation.

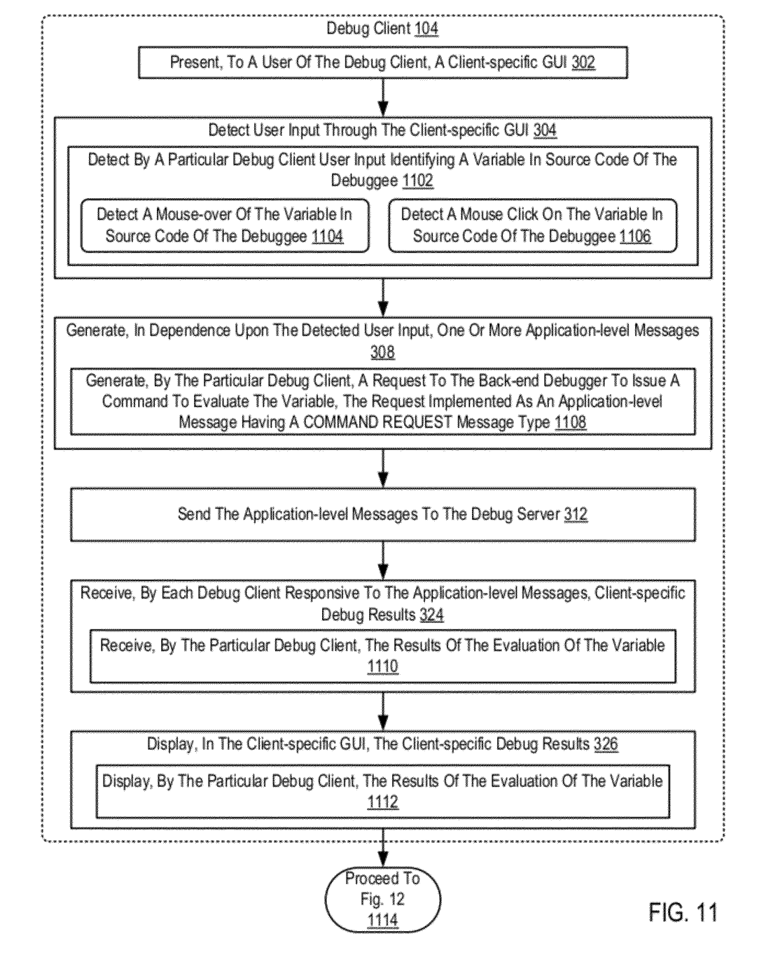

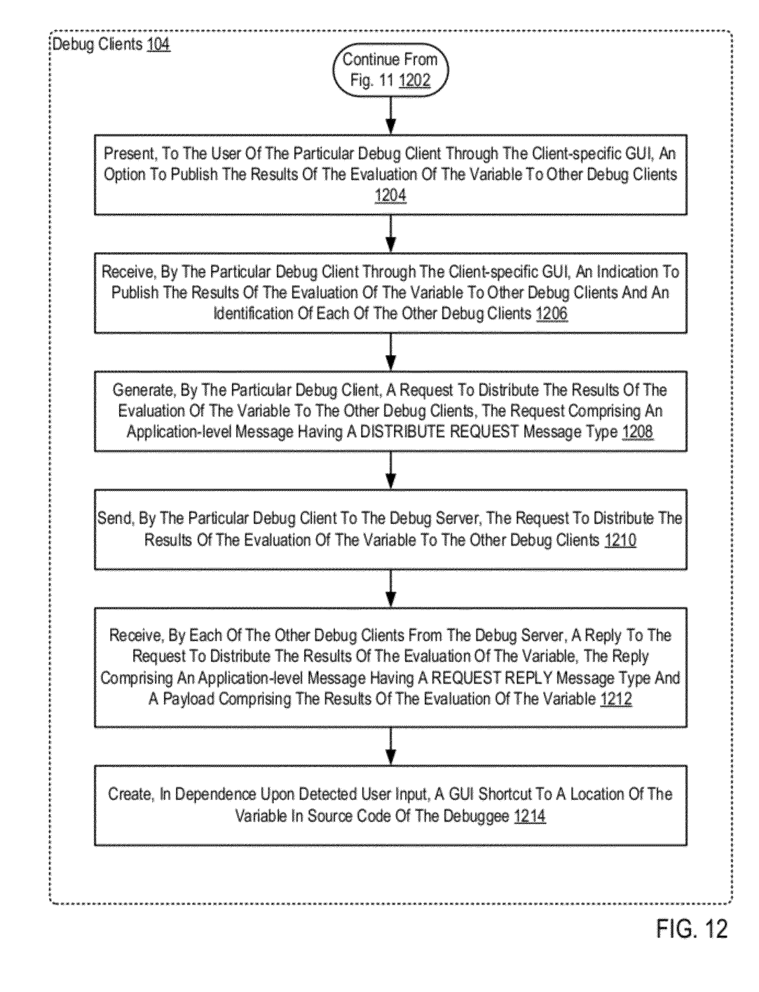

As mentioned above, FIG. 10 is directed primarily at operation of the debug server (102). By contrast, FIGS. 11 and 12 present a method carried out primarily by the debug clients (104). For further explanation, FIG. 11 sets forth a flowchart illustrating a further exemplary method of collaborative software debugging in a distributed system in accordance with embodiments of the present invention. The method of FIG. 11 is similar to the method of FIG. 3 including, as it does, presenting (302) a client-specific GUI, detecting (304) user input, generating (308) one or more application-level messages, sending (312) the application-level messages to the debug server, receiving (324) client-specific debug results, and displaying (326) the client-specific debug results in the client-specific GUI.

The method of FIG. 11 differs from the method of FIG. 3, however, in that in the method of FIG. 11, detecting (304) user input is carried out by detecting (1102) by a particular debug client user input identifying a variable in source code of the debuggee. In the method of FIG. 11, detecting (1102) user input identifying a variable may be carried out in various ways including detecting (1104) a mouse-over of the variable in source code, detecting (1106) a mouse click (such as a ‘right-click’) on the variable in source code, and so on as will occur to readers of skill in the art.

In the method of FIG. 11, generating (308) one or more application-level messages is carried out by generating (1108), by the particular debug client, a request to issue a command to the back-end debugger to evaluate the variable. In the method of FIG. 11, the request includes an application-level message having a COMMAND REQUEST message type.

In the method of FIG. 11, receiving (324) client-specific debug results includes receiving (1110), by the particular debug client, the results of the evaluation of the variable and displaying (326), in the client-specific GUI, the client-specific debug results includes displaying (1112), by the particular debug client, the results of the evaluation of the variable.

The method of FIG. 11, continues by proceeding (1114) to FIG. 12. FIG. 12 sets forth a flowchart illustrating a further exemplary method of collaborative software debugging in a distributed system in accordance with embodiments of the present invention. The method of FIG. 12 includes presenting (1204), to the user of the particular debug client through the client-specific GUI, an option to publish the results of the evaluation of the variable to other debug clients. Such an option may be presented in various ways—as a GUI button, in a drop-down list, as a menu item in a menu of a menu bar, and so on as will occur to readers of skill in the art.

The method of FIG. 12 also includes receiving (1204), by the particular debug client through the client-specific GUI, an indication to publish the results of the evaluation of the variable to other debug clients and an identification of each of the other debug clients. An indication to publish the results is a user's input—a selection of a menu item, a selection of an item in a drop-down list, an invocation of a GUI button and so on. The debug client may also present a list of available debug clients to a user from which the user may select debug clients to publish the results of the evaluation of the variable. Such clients may be selected individually, as a group, or by selecting all available clients. In some embodiments, once results of an evaluation of a variable are published or ‘shared’ with other debug clients, the graphical representation of the results of the evaluation may be varied to indicate the results are shared. The ‘sharing’ of results may graphically represented in various ways, including, for example, changing color of an icon associated with results upon sharing the results, presenting, approximate to the results, an icon upon sharing the results when there was no icon present before the sharing, and in other ways as will occur to readers of skill in the art.

The method of FIG. 12 also includes generating (1208), by the particular debug client, a request to distribute the results of the evaluation of the variable to the other debug clients. In the method of FIG. 12, the request may be implemented as an application-level message having a DISTRIBUTE REQUEST message type. The method of FIG. 12 also includes sending (1210), by the particular debug client to the debug server, the request to distribute the results of the evaluation of the variable to the other debug clients and receiving (1212), by each of the other debug clients from the debug server, a reply to the request to distribute the results of the evaluation of the variable, The reply to the distribute request may be implemented as an application-level message having a REQUEST REPLY message type and a payload that includes the results of the evaluation of the variable.

The method of FIG. 12 also includes creating (1214), in dependence upon detected user input, a GUI shortcut to a location of the variable in source code of the debuggee. The shortcut, like the results of the evaluation, may also be published to one, some, or all of the other debug clients. The shortcut enables a user to quickly locate the variable in source—at the push of a GUI button for example—during execution of the debuggee for debug purposes or when the debuggee is not executing.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart, block diagrams, and sequence diagrams, in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the method comprising:
receiving, by the debug server from the debug clients asynchronously during a debug session of the debuggee, a plurality of application-level messages;
routing, by the message router in accordance with an application-level message passing protocol, the application-level messages among the debug clients, the debug administrator, and the back-end debugger, including providing distributed control of the back-end debugger to the debug clients with application-level messages routed to the back-end debugger; and
returning, by the debug server to the debug clients in response to the application-level messages routed to the back-end debugger, client-specific debug results.

2. The method of claim 1 further comprising:
receiving a plurality of application-level messages further comprises receiving from a requesting debug client, a request to issue a command to the back-end debugger to evaluate a variable, the request comprising an application-level message having a COMMAND REQUEST message type;
routing the application-level messages further comprises issuing, to the back-end debugger, the command to evaluate the variable;
the method further comprises: evaluating, by the back-end debugger responsive to the issued command, the variable; and providing, to the message router, the results of the evaluation; and
returning client-specific debug results further comprises returning, to the requesting debug client, the results of the evaluation.

3. The method of claim 1 wherein:
receiving a plurality of application-level messages further comprises: receiving, by the message router from a requesting debug client, a request to join the debug session, the request comprising an application-level message having a JOIN REQUEST message type and an identification of one or more intended recipients; and sending, by the message router to the requesting debug client, a confirmation of receipt of the request to join, the confirmation comprising an application-level message having a CONFIRMATION REPLY message type;
routing the application-level messages further comprises forwarding the request to join the debug session to the debug administrator; and
the method further comprises: registering, by the debug administrator responsive to the request to join, the requesting debug client in the debug session, including assigning the requesting debug client a client identifier unique to the debug session; returning, by the debug administrator to the message router, the assigned client identifier; sending, by the message router to the requesting debug client, a reply to the request to join, the reply comprising an application-level message having a REQUEST REPLY message type, an indication of future replies responsive to the request to join, and a payload comprising the assigned client identifier; and sending, by the message router to debug clients identified as intended recipients in the request to join, an additional reply to the request to join, the additional reply comprising an application-level message having a REQUEST REPLY message type, an indication of future replies responsive to the request to join, and a payload comprising the assigned client identifier and an indication that the requesting debug client is registered in the debug session.

4. The method of claim 1 wherein:
receiving a plurality of application-level messages further comprises: receiving, by the message router from a requesting debug client, a request to leave the debug session, the request comprising an application-level message having a LEAVE REQUEST message type, an identification of one or more intended recipients, and a payload to distribute to the intended recipients; and sending, by the message router to the requesting debug client, a confirmation of receipt of the request to leave, the confirmation comprising an application-level message having a CONFIRMATION REPLY message type;
routing the application-level messages further comprises forwarding the request to leave the debug session to the debug administrator; and
the method further comprises:
unregistering, by the debug administrator responsive to the request to leave, the requesting debug client from the debug session, including unassigning the requesting debug client's client identifier;
sending, by the message router to debug clients identified as intended recipients in the request to leave, a reply to the request to leave, the reply comprising an application-level message having a REQUEST REPLY message type, an indication of future replies responsive to the request to leave, and the payload included in the request to leave.

5. The method of claim 1 wherein:
receiving a plurality of application-level messages further comprises: receiving, by the message router from a requesting debug client, a request to distribute data to debug clients registered in the debug session, the request comprising an application-level message having a DISTRIBUTE REQUEST message type, an identification of one or more intended recipients, and a payload to distribute to the intended recipients; and sending, by the message router to the requesting debug client, a confirmation of receipt of the request to distribute data, the confirmation comprising an application-level message having a CONFIRMATION REPLY message type; and
the method further comprises sending, by the message router to debug clients identified as intended recipients in the request to distribute data, a reply to the request to distribute data, the reply comprising an application-level message having a REQUEST REPLY message type, an indication of future replies responsive to the request to distribute data, and the payload included in the request to distribute data.

6. The method of claim 1 wherein:
receiving a plurality of application-level messages further comprises: receiving, by the message router from a requesting debug client, a request to issue a command to the back-end debugger, the request comprising an application-level message having a COMMAND REQUEST message type, an identification of one or more intended recipients of results of executing the command, and a payload comprising the command to issue to the back-end debugger and sending, by the message router to the requesting debug client, a confirmation of receipt of the request to issue the command, the confirmation comprising an application-level message having a CONFIRMATION REPLY message type;
routing the application-level messages among the debug clients, the debug administrator, and the back-end debugger further comprises issuing the command to the back-end debugger;
the method further comprises: executing, by the back-end debugger, the issued command; and returning, to the message router, results of the execution of the issued command; and
returning client-specific debug results further comprises: receiving, by the message router from the back-end debugger, results of executing the issued command; and sending, by the message router to each of the requesting debug client and debug clients identified as intended recipients in the request to issue the command, a reply to the request to issue the command, the reply comprising an application-level message having a REQUEST REPLY message type, an indication of future replies responsive to the request to issue the command, and a payload comprising the results of executing the issued command.

7. The method of claim 1 wherein:
receiving a plurality of application-level messages further comprises: receiving, by the message router from a requesting debug client, a request to establish, with the back-end debugger, an event notification associated with a particular event during the debug session, the request comprising an application-level message having an EVENT REQUEST message type, an identification of one or more intended recipients of notifications of the of the event, and a payload comprising a command to issue to the back-end debugger to establish the event notification; and sending, by the message router to the requesting debug client, a confirmation of receipt of the request to establish the event notification, the confirmation comprising an application-level message having a CONFIRMATION REPLY message type;
routing the application-level messages among the debug clients, the debug administrator, and the back-end debugger further comprises issuing, to the back-end debugger, the command to establish the event notification;
the method further comprises: executing, by the back-end debugger, the issued command including establishing the event notification associated with the particular event and assigning the event notification an event identifier; returning, by the back-end debugger to the message router, the event identifier; sending, by the message router to each of the requesting debug client and debug clients identified as intended recipients in the request to establish the event notification, a reply to the request to establish the event notification, the reply comprising an application-level message having a REPLY REQUEST message type and a payload comprising the event identifier; encountering, by back-end debugger during the debug session, the particular event associated with the event notification; and providing, by the back-end debugger to the message router, information describing the particular event and the event identifier; and
returning client-specific debug results further comprises: receiving, by the message router from the back-end debugger, the information describing the particular event and the event identifier; and sending, by the message router to each of the requesting debug client and debug clients identified as intended recipients in the request to establish the event notification, a reply to the request to establish the event notification, the reply comprising an application-level message having an EVENT REPLY message type, an indication of future replies responsive to the request establish the event notification, and a payload comprising the information describing the particular event and the event identifier.

8. The method of claim 1 wherein:
receiving a plurality of application-level messages further comprises: receiving, by the message router from a requesting debug client, a request to register a group of debug clients, the request comprising an application-level message having a GROUP REGISTER REQUEST message type, an identification of one or more intended recipients, and a payload comprising client identifiers of a plurality of debug clients to include in the group of debug clients; and sending, by the message router to the requesting debug client, a confirmation of receipt of the request to register the group, the confirmation comprising an application-level message having a CONFIRMATION REPLY message type; and
routing the application-level messages among the debug clients, the debug administrator, and the back-end debugger further comprises routing the request to register the group of debug clients to the debug administrator; and
the method further comprises:
registering the group of debug clients, including assigning the group of debug clients a group identifier unique within the debug session; and
sending, by the message router to each of the requesting debug client and the debug clients identified as intended recipients in the request to register the group of debug clients, a reply to the request to register the group of debug clients, the reply comprising an application-level message having a REQUEST REPLY message type, an indication of future replies responsive to the request to register the group of debug clients, and a payload comprising the assigned group identifier.

9. A method of collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the method comprising:
presenting, by each debug client to a user of the debug client, a client-specific graphical user interface (‘GUI’), the client-specific GUI comprising a client-specific display of a debug session of the debuggee;
detecting, by each debug client, user input through the client-specific GUI;
generating, by each debug client in dependence upon the detected user input, one or more application-level messages;
sending, by each debug client, the application-level messages to the debug server;
receiving, by each debug client responsive to the application-level messages, client-specific debug results; and
displaying, by each debug client in the client-specific GUI, the client-specific debug results.

10. The method of claim 9 wherein:
detecting, by each debug client, user input through the client-specific GUI further comprises detecting by a particular debug client user input identifying a variable in source code of the debuggee;
generating, by each debug client in dependence upon the detected user input, one or more application-level messages further comprises generating, by the particular debug client, a request to issue a command to the back-end debugger to evaluate the variable, the request comprising an application-level message having a COMMAND REQUEST message type;
receiving client-specific debug results further comprises receiving, by the particular debug client, the results of the evaluation of the variable; and
displaying, in the client-specific GUI, the client-specific debug results further comprises displaying, by the particular debug client, the results of the evaluation of the variable.

11. The method of claim 10 further comprising:
presenting, to the user of the particular debug client through the client-specific GUI, an option to publish the results of the evaluation of the variable to other debug clients;
receiving, by the particular debug client through the client-specific GUI, an indication to publish the results of the evaluation of the variable to other debug clients and an identification of each of the other debug clients; and
generating, by the particular debug client, a request to distribute the results of the evaluation of the variable to the other debug clients, the request comprising an application-level message having a DISTRIBUTE REQUEST message type; and
sending, by the particular debug client to the debug server, the request to distribute the results of the evaluation of the variable to the other debug clients; and
receiving, by each of the other debug clients from the debug server, a reply to the request to distribute the results of the evaluation of the variable, the reply comprising an application-level message having a REQUEST REPLY message type and a payload comprising the results of the evaluation of the variable.

12. The method of claim 10 further comprising creating, in dependence upon detected user input, a GUI shortcut to a location of the variable in source code of the debuggee.

13. The method of claim 9 wherein:
generating one or more application-level messages further comprises generating, by a requesting debug client, a request to join the debug session, the request comprising an application-level message having a JOIN REQUEST message type and an identification of one or more intended recipients;
sending the application-level messages to the debug server further comprises sending, by the requesting debug client to the debug server, the request to join the debug session; and
receiving client-specific debug results further comprises receiving, by the requesting debug client a confirmation of receipt of the request to join, the confirmation comprising an application-level message having a CONFIRMATION REPLY message type and subsequently receiving, by the requesting debug client and debug clients identified as intended recipients in the request to join, a reply to the request to join, the reply comprising an application-level message having a REQUEST REPLY message type, an indication of future replies responsive to the request to join, and a payload comprising a client identifier assigned to the requesting debug client.

14. The method of claim 9 wherein:
generating one or more application-level messages further comprises generating, by a requesting debug client, a request to leave the debug session, the request comprising an application-level message having a LEAVE REQUEST message type, an identification of one or more intended recipients, and a payload to distribute to the intended recipients;
sending the application-level messages to the debug server further comprises sending, by the requesting debug client to the debug server, the request to leave the debug session; and
receiving client-specific debug results further comprises receiving, by the requesting debug client a confirmation of receipt of the request to leave the debug session, the confirmation comprising an application-level message having a CONFIRMATION REPLY message type and receiving, by the debug clients identified as intended recipients in the request to leave, a reply to the request to leave, the reply comprising an application-level message having a REQUEST REPLY message type, an indication of future replies responsive to the request to leave, and the payload included in the request to leave.

15. The method of claim 9 wherein:
generating one or more application-level messages further comprises generating, by a requesting debug client, a request to distribute data to debug clients registered in the debug session, the request comprising an application-level message having a DISTRIBUTE REQUEST message type, an identification of one or more intended recipients, and a payload to distribute to the intended recipients;
sending the application-level messages to the debug server further comprises sending, by the requesting debug client to the debug server, the request to distribute data to debug clients registered in the debug session; and
receiving client-specific debug results further comprises receiving, by the requesting debug client a confirmation of receipt of the request to distribute data, the confirmation comprising an application-level message having a CONFIRMATION REPLY message type and receiving, by the debug clients identified as intended recipients in the request to distribute data, a reply to the request to distribute data, the reply comprising an application-level message having a REQUEST REPLY message type, an indication of future replies responsive to the request to distribute data, and the payload included in the request to distribute data.

16. The method of claim 9 wherein:
generating one or more application-level messages further comprises generating, by a requesting debug client, a request to issue a command to the back-end debugger, the request comprising an application-level message having a COMMAND REQUEST message type, an identification of one or more intended recipients of results of executing the command, and a payload comprising the command to issue to the back-end debugger,
sending the application-level messages to the debug server further comprises sending, by the requesting debug client to the debug server, the request to issue a command to the back-end debugger; and
receiving client-specific debug results further comprises: receiving, by the requesting debug client from the debug server, a confirmation of receipt of the request to issue the command, the confirmation comprising an application-level message having a CONFIRMATION REPLY message type; and receiving, by each of the requesting debug client and the debug clients identified as intended recipients in the request to issue the command, a reply to the request to issue the command, a reply to the request to issue the command, the reply comprising an application-level message having a REQUEST REPLY message type, an indication of future replies responsive to the request to issue the command, and a payload comprising the results of executing the issued command.

17. The method of claim 9 wherein:
generating one or more application-level messages further comprises generating, by a requesting debug client, a request to establish, with the back-end debugger, an event notification associated with a particular event during the debug session, the request comprising an application-level message having an EVENT REQUEST message type, an identification of one or more intended recipients of notifications of the of the event, and a payload comprising a command to issue to the back-end debugger to establish the event notification;
sending the application-level messages to the debug server further comprises sending, by the requesting debug client to the debug server, the request to establish the event notification; and
receiving client-specific debug results further comprises:
receiving, by the requesting debug client from the debug server, a confirmation of receipt of the request to establish the event notification;
receiving, by the requesting debug client and debug clients identified as intended recipients in the request to establish the event notification from the debug server, an event identifier identifying the established event notification; and a reply to the request to establish the event notification, the reply comprising an application-level message having an REQUEST REPLY message type, an indication of future replies responsive to the request establish the event notification, and a payload comprising the event identifier; and
upon the back-end debugger's encountering the event, receiving, by each of the requesting debug client and the debug clients identified as intended recipients in the request to establish the event notification from the debug server, a subsequent reply to the request to establish the event notification, the subsequent reply comprising an application-level message having an EVENT REPLY message type, an indication of future replies responsive to the request establish the event notification, and a payload comprising the information describing the particular event and the event identifier.

18. The method of claim 9 wherein:
generating one or more application-level messages further comprises generating, by a requesting debug client, a request to register a group of debug clients, the request comprising an application-level message having a GROUP REGISTER REQUEST message type, an identification of one or more intended recipients, and a payload comprising client identifiers of a plurality of debug clients to include in the group of debug clients;
sending the application-level messages to the debug server further comprises sending, by the requesting debug client to the debug server, the request to register the group of debug clients; and
receiving client-specific debug results further comprises: receiving, by the requesting debug client from the debug server, a confirmation reply comprising an application-level message having a CONFIRMATION REPLY message type; and receiving, by each of the requesting debug client and the debug clients identified as intended recipients in the request to register the group of debug clients from the debug server, a reply to the request to register the group of debug clients, the reply comprising an application-level message having a REQUEST REPLY message type, an indication of future replies responsive to the request to register the group of debug clients, and a payload comprising the assigned group identifier.

19. An apparatus for collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the apparatus comprising a computer processor, a computer memory operatively coupled to the computer processor, the computer memory having disposed within it computer program instructions that, when executed by the computer processor, cause the apparatus to carry out the steps of:
presenting, by each debug client to a user of the debug client, a client-specific graphical user interface (‘GUI’), the client-specific GUI comprising a client-specific display of a debug session of the debuggee;
detecting, by each debug client, user input through the client-specific GUI;
generating, by each debug client in dependence upon the detected user input, one or more application-level messages;
sending, by each debug client, the application-level messages to the debug server;
receiving, by each debug client responsive to the application-level messages, client-specific debug results; and
displaying, by each debug client in the client-specific GUI, the client-specific debug results.

20. The apparatus of claim 19 wherein:
detecting, by each debug client, user input through the client-specific GUI further comprises detecting by a particular debug client user input identifying a variable in source code of the debuggee;
generating, by each debug client in dependence upon the detected user input, one or more application-level messages further comprises generating, by the particular debug client, a request to issue a command to the back-end debugger to evaluate the variable, the request comprising an application-level message having a COMMAND REQUEST message type;
receiving client-specific debug results further comprises receiving, by the particular debug client, the results of the evaluation of the variable; and
displaying, in the client-specific GUI, the client-specific debug results further comprises displaying, by the particular debug client, the results of the evaluation of the variable.

21. The apparatus of claim 20 further comprising computer program instructions that, when executed by the computer processor, cause the apparatus to carry out the steps of:
presenting, to the user of the particular debug client through the client-specific GUI, an option to publish the results of the evaluation of the variable to other debug clients;
receiving, by the particular debug client through the client-specific GUI, an indication to publish the results of the evaluation of the variable to other debug clients and an identification of each of the other debug clients; and
generating, by the particular debug client, a request to distribute the results of the evaluation of the variable to the other debug clients, the request comprising an application-level message having a DISTRIBUTE REQUEST message type; and
sending, by the particular debug client to the debug server, the request to distribute the results of the evaluation of the variable to the other debug clients; and
receiving, by each of the other debug clients from the debug server, a reply to the request to distribute the results of the evaluation of the variable, the reply comprising an application-level message having a REQUEST REPLY message type and a payload comprising the results of the evaluation of the variable.

22. A computer program product for collaborative software debugging in a distributed system, the distributed system comprising a debug server, a plurality of debug clients, and a data communications network, the debug server coupled for data communications to the plurality of debug clients through the data communications network, the debug server comprising a debug administrator, a message router, a back-end debugger, and a debuggee, the computer program product disposed upon a computer readable storage medium, the computer program product comprising computer program instructions that, when executed by a computer processor of a computer, cause the computer to carry out the steps of:
presenting, by each debug client to a user of the debug client, a client-specific graphical user interface (‘GUI’), the client-specific GUI comprising a client-specific display of a debug session of the debuggee;
detecting, by each debug client, user input through the client-specific GUI;
generating, by each debug client in dependence upon the detected user input, one or more application-level messages;
sending, by each debug client, the application-level messages to the debug server;
receiving, by each debug client responsive to the application-level messages, client-specific debug results; and
displaying, by each debug client in the client-specific GUI, the client-specific debug results.

23. The computer program product of claim 22 wherein:
detecting, by each debug client, user input through the client-specific GUI further comprises detecting by a particular debug client user input identifying a variable in source code of the debuggee;
generating, by each debug client in dependence upon the detected user input, one or more application-level messages further comprises generating, by the particular debug client, a request to issue a command to the back-end debugger to evaluate the variable, the request comprising an application-level message having a COMMAND REQUEST message type;
receiving client-specific debug results further comprises receiving, by the particular debug client, the results of the evaluation of the variable; and
displaying, in the client-specific GUI, the client-specific debug results further comprises displaying, by the particular debug client, the results of the evaluation of the variable.

24. The computer program product of claim 23 further comprising computer program instructions that, when executed by the computer processor of the computer, cause the computer to carry out the steps of:
presenting, to the user of the particular debug client through the client-specific GUI, an option to publish the results of the evaluation of the variable to other debug clients;
receiving, by the particular debug client through the client-specific GUI, an indication to publish the results of the evaluation of the variable to other debug clients and an identification of each of the other debug clients; and
generating, by the particular debug client, a request to distribute the results of the evaluation of the variable to the other debug clients, the request comprising an application-level message having a DISTRIBUTE REQUEST message type; and
sending, by the particular debug client to the debug server, the request to distribute the results of the evaluation of the variable to the other debug clients; and
receiving, by each of the other debug clients from the debug server, a reply to the request to distribute the results of the evaluation of the variable, the reply comprising an application-level message having a REQUEST REPLY message type and a payload comprising the results of the evaluation of the variable.
